(19) United States
(12) Patent Application Publication
(10) Pub. No.: US 2016/0034178 A1
(43) Pub. Date: Feb. 4, 2016

(54) VIRTUAL KEYBOARD

(71) Applicant: Joohyun Yoon, Seoul (KR)

(72) Inventor: Joohyun Yoon, Seoul (KR)

(73) Assignee: LG CNS CO., LTD., Seoul (KR)

(21) Appl. No.: 13/344,050

(22) Filed: Jan. 5, 2012

(51) Int. Cl. G06F 3/0488; G06F 17/21; G06F 17/22; G06F 3/041

(52) U.S. Cl. CPC G06F 3/04886; G06F 3/0412; G06F 3/04883; G06F 17/212; G06F 17/2247

(57) ABSTRACT

Embodiments of the present invention relate to a virtual keyboard. More specifically, the present invention provides a virtual keyboard having a common text format tool bar that works all applications. When a virtual keyboard trigger is received, the device examines the text input characteristics. The present invention provides at least one text formatter on the touch screen. When one text format is selected, then that text format is displayed. The virtual keyboard includes an HTML (hypertext markup language) formatted text interface.

### TECHNICAL FIELD

In general, embodiments of the present invention relate to a keyboard and more particularly to a virtual keyboard.

### BACKGROUND

A virtual keyboard is a software component that allows a user to enter characters. Virtual keyboards are used in many mobile devices. Many of the current mobile devices use a virtual keyboard having a touch screen to enter characters. The touch screen keyboard is a graphical interface which acts as the keyboard. Virtual keyboards are commonly used as an on-screen input method in devices with no physical keyboard, where there is no room for one, such as a pocket computer, personal digital assistant (PDA), tablet computer or touchscreen equipped mobile phone. It is common for the user to input text by tapping a virtual keyboard built into the operating system of the device. Virtual keyboards are also used as features of emulation software for systems that have fewer buttons than a computer keyboard would have.

Typically, each application on the device has its own unique formatting tool bar when a user uses the application. For example, an e-mail editor uses its own character format which is different than the character formats of other applications on the mobile device. Heretofore, several unsuccessful attempts have been made to address these shortcomings.

U.S. Pat. No. 8,059,101 discloses a systems, methods, and devices for interpreting manual swipe gestures as input to a virtual keyboard.

U.S. Patent Application 20090058823 discloses displays of accented or related characters for characters selected by a user through a virtual keyboard.

U.S. Patent Application 20100060585 discloses a simplified virtual keyboard having a plurality of reserved keys for entering input characters and a traditional layout key for switching the simplified virtual keyboard layout to the traditional virtual keyboard layout.

None of these references, however, teach a virtual keyboard having a common text format tool bar that works with multiple applications.

### SUMMARY

In general, embodiments of the present invention relate to a virtual keyboard. More specifically, the present invention provides a virtual keyboard having a common text format tool bar that works all applications. When a virtual keyboard trigger is received, the device examines the text input characteristics. The present invention provides at least one text formatter on the touch screen. When one text format is selected, then that text format is displayed. The virtual keyboard includes an HTML (hypertext markup language) formatted text interface.

A first aspect of the present invention provides a system for providing a virtual keyboard, comprising: an application, comprising: a text input window configured to receive input; and a text formatting module configured to format text characters; a controller, comprising: a virtual keyboard provider configured to receive a virtual keyboard trigger; a virtual keyboard processor; and a display processor configured to display a virtual keyboard; and a touch screen.

A second aspect of the present invention provides a method for displaying a virtual keyboard, comprising: receiving a virtual keyboard trigger signal; detecting at least one text characteristic; formatting a plurality of text characters using the at least one text characteristic; providing at least one virtual keyboard; and adjusting at least one display of an application or the at least one virtual keyboard.

A third aspect of the present invention provides a method for deploying a virtual keyboard, comprising: receiving a virtual keyboard trigger signal; detecting at least one text characteristic; formatting a plurality of text characters using the at least one text characteristic; providing at least one virtual keyboard; and adjusting at least one display of an application or the at least one virtual keyboard.

A fourth aspect of the present invention provides a computer program product for displaying a virtual keyboard, the computer program product comprising a computer readable storage media, and program instructions stored on the computer readable storage media, to: receive a virtual keyboard trigger signal; detect at least one text characteristic; format a plurality of text characters using the at least one text characteristic; provide at least one virtual keyboard; and adjust at least one display of an application or the at least one virtual keyboard.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a virtual keyboard block diagram according to an embodiment of the present invention.

FIG. 2 depicts a virtual keyboard according to an embodiment of the present invention.

FIG. 3 depicts a flow diagram showing an implementation of the virtual keyboard according to an embodiment of the present invention.

FIG. 4 depicts a formatted text input process flow diagram according to the present invention.

FIG. 5 depicts a text formatter key code according to the present invention.

FIG. 6 depicts a formatted text in format mode according to the present invention.

FIG. 7 depicts a formatted text in original mode according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As mentioned above, embodiments of the present invention relate to a virtual keyboard. More specifically, the present invention provides a virtual keyboard having a common text format tool bar that works all applications. When a virtual keyboard trigger is received, the device examines the text input characteristics. The present invention provides at least one text formatter on the touch screen. When one text format is selected, then that text format is displayed. The

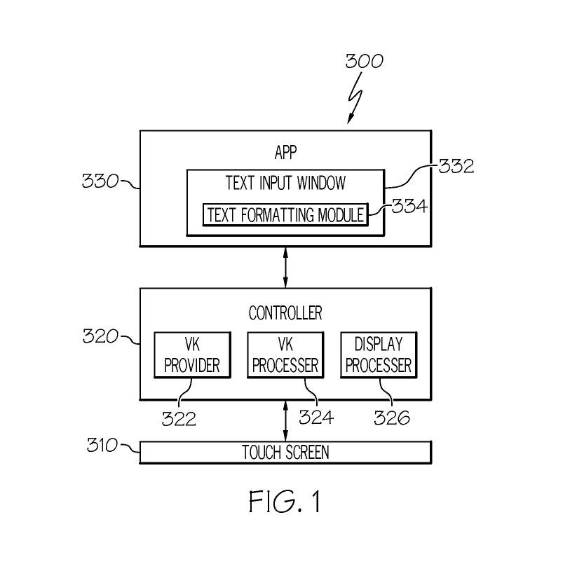

FIG. 1 depicts an example virtual keyboard block diagram 300 according to an embodiment of the present invention. A touch screen 310, controller 320, and application 330 are shown. The touch screen 310 may be used as an input device as well as a display device. In one example, the keyboard function of the touch screen 310 may be activated with a human finger. In other examples, the keyboard function may be active with a stylus or other means. The controller 320 includes a keyboard provider 322, virtual keyboard (VK) processor 324 and a display processor 326. The controller 320 manages the application 330 based on the touch screen 310 input. The controller 320 interprets the input by the user and operates the application 330. For the display screen output, the controller 320 displays outputs from the application 330 onto the touch screen 310.

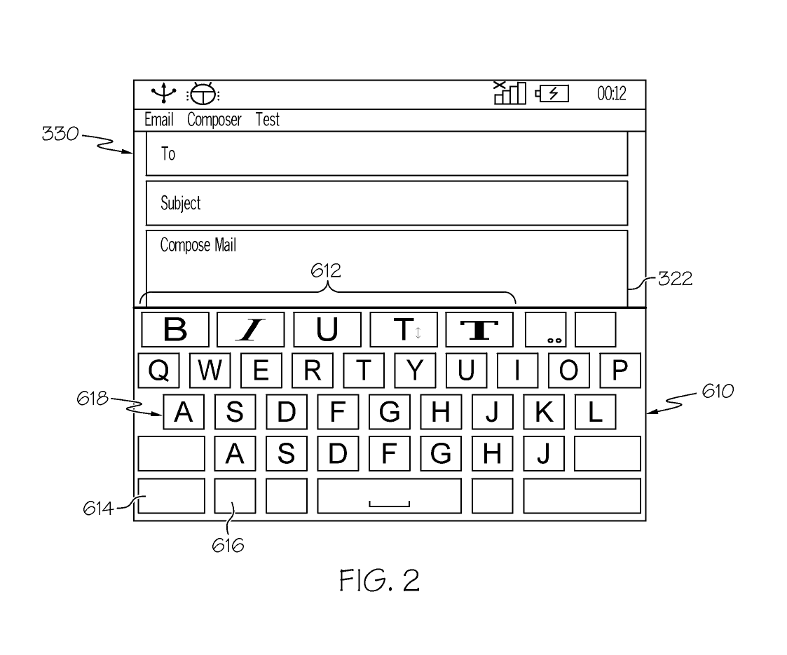

The application 330 includes a touch screen text input window 332. The text input window 332 includes a text formatting module 334. The text formatting module 334 may use a markup language (e.g., HTML) to display characters on the screen. For example, the text formatting module 334 may display bold, underline, italic, or color in order to increase the visual effects of the displayed text. The application 330 may contain the text input window 332 which contains the format text characteristics. For example, when the text input screen is touched by the user, the keyboard provider 322 displays the virtual keyboard 610 on the screen, as shown in FIG. 2. During the process, the display processor 326 places the virtual keyboard 610 in the application 330.

FIG. 2 depicts an example virtual keyboard according to an embodiment of the present invention. The virtual keyboard may include one of more of a text formatter 612, text format toggle key 614, a format mode toggle key 616 and multiple alphabet keys 618. At least, one text formatter 612, such as Bold (B), Italic (I), underline (U), character size (T [symbol] ) and character color (T) may be included. At least one text formatter 612 may be offered separately from the multiple alphabet keys. For example, at least one text formatter 612 may be placed above the alphabet keys. Text format toggle key 614 toggles at least one text formatter 612 when the text format toggle key 614 is touched. For example, when the format toggle key 614 is touched, the keyboard 610 format can be changed. When the virtual keyboard layout is changed, the display processor 326 may increase the size of the text input window. When the text formatter toggle key 614 is activated, the virtual keyboard returns to the original size.

The format mode toggle key 616 may have two modes: original mode and format mode. The original mode displays the text on the input window and the format mode is used to format the content on the text input window 322 and display. To that end, the format mode toggle key 616 toggles between the original mode and the format mode.

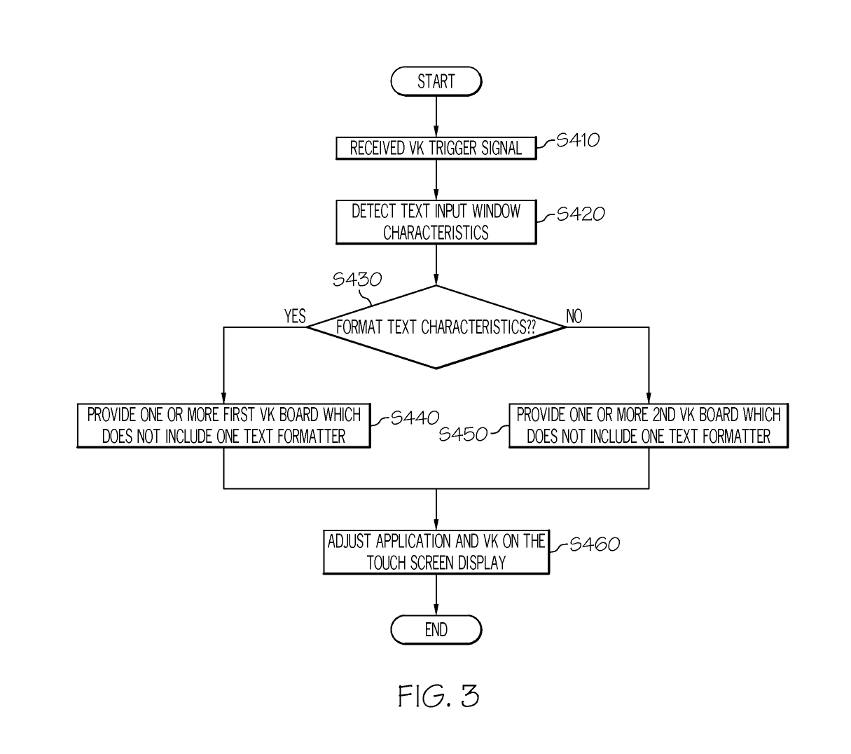

FIG. 3 depicts an example flow diagram showing an implementation of the virtual keyboard according to an embodiment of the present invention. When the virtual keyboard provider module 322 receives the virtual keyboard trigger, it extracts the characteristics of the input from the text input window 332 as shown in steps S410 and S420. The type of data being placed in a text field is determined and used to help an input method decide how to let the user enter text. The constants here correspond to those defined by InputType (shown in Table 1 below). Generally a single value is selected, though some may be combined together as indicated. Setting this attribute to anything besides none also implies that the text is editable.

TABLE 1

| Constant | Value | Description |
|---|---|---|
| None | 0x00000000 | There is no content type. The |
| | | text is not editable. |
| Text | 0x00000001 | Just plain old text. |
| textCapCharacters | 0x00001001 | Can be combined with text and |
| | | its variations to request |
| | | capitalization of all characters. |
| textCapWords | 0x00002001 | Can be combined with text and |
| | | its variations to request |
| | | capitalization of the first |
| | | character of every word. |
| textCapSentences | 0x00004001 | Can be combined with text and |
| | | its variations to request |
| | | capitalization of the first |
| | | character of every sentence. |
| textAutoCorrect | 0x00008001 | Can be combined with text and |
| | | its variations to request auto- |
| | | correction of text being input. |
| textAutoComplete | 0x00010001 | Can be combined with text and |
| | | its variations to specify that this |
| | | field will be doing its own auto- |
| | | completion and talking with the |
| | | input method appropriately. |
| textMultiLine | 0x00020001 | Can be combined with text and |
| | | its variations to allow multiple |
| | | lines of text in the field. If this |
| | | flag is not set, the text field will |
| | | be constrained to a single line. |
| textImeMultiLine | 0x00040001 | Can be combined with text and |
| | | its variations to indicate that |
| | | though the regular text view |
| | | should not be multiple lines, the |
| | | IME should provide multiple |
| | | lines if it can. |
| textNoSuggestions | 0x00080001 | Can be combined with text and |
| | | its variations to indicate that the |
| | | IME should not show any |
| | | dictionary-based word |
| | | suggestions. |
| texture | 0x00000011 | Text that will be used as a URI. |
| textEmailAddress | 0x00000021 | Text that will be used as an e- |
| | | mail address. |
| textEmailSubject | 0x00000031 | Text that is being supplied as |
| | | the subject of an e-mail. |
| textShortMessage | 0x00000041 | Text that is the content of a |
| | | short message. |
| textLongMessage | 0x00000051 | Text that is the content of a |
| | | long message. |
| textPersonName | 0x00000061 | Text that is the name of a |
| | | person. |
| textPostalAddress | 0x00000071 | Text that is being supplied as a |
| | | postal mailing address. |
| textPassword | 0x00000081 | Text that is a password. |
| textVisiblePassword | 0x00000091 | Text that is a password that |
| | | should be visible. |
| textWebEditText | 0x000000a1 | Text that is being supplied as |
| | | text in a web form. |
| textFilter | 0x000000b1 | Text that is filtering some other |
| | | data. |
| textPhonetic | 0x000000c1 | Text that is for phonetic |
| | | pronunciation, such as a |
| | | phonetic name field in a |
| | | contact entry. |
| textWebEmailAddress | 0x000000d1 | Text that will be used as an e- |
| | | mail address on a web form. |
| textWebPassword | 0x000000e1 | Text that will be used as a |
| | | password on a web form. |
| Number | 0x00000002 | A numeric only field. |
| numberSigned | 0x00001002 | Can be combined with number |
| | | and its other options to allow a |
| | | signed number. |
| numberDecimal | 0x00002002 | Can be combined with number |
| | | and its other options to allow a |
| | | decimal (fractional) number. |
| numberPassword | 0x00000012 | A numeric password field. |
| Phone | 0x00000003 | For entering a phone number. |
| Datetime | 0x00000004 | For entering a date and time. |
| Date | 0x00000014 | For entering a date. |
| Time | 0x00000024 | For entering a time. |

The triggering input of the text input window can be touch, voice, gesture, or push button of the device 300. When a trigger input (e.g., a touch) is sensed at the text input window 332, the text input window creates a virtual keyboard trigger signal. The virtual keyboard provider 322 receives the trigger signal and extracts the characteristics of the text input. The touch screen 310 determines the touch position and sends the position to the controller 320. The touch screen 310 and the controller 320 use a chart to reference each other. If the touch position is included in the text input window, then the text input window 332 can create the virtual keyboard trigger and the controller 320 can produce the trigger signal to the virtual keyboard provider 332.

The VK (virtual keyboard) provider module 322 checks whether the virtual keyboard (VK) 610 is provided when it receives the trigger signal. When the VK is provided, as shown in step S440, the VK provider 322 discards the signal. If the VK is not provided, the VK provider 322 examines the text window input characteristics and provides the proper keyboard. If the touch position is not in the text window 322, then the application produces a virtual keyboard ‘remove’ signal and the controller 320 provides the VK remove signal to the VK provider 322. VK provider 322 receives the remove signal and checks whether VK is provided currently. When the VK is provided, the VK provider 322 deletes the current VK. Otherwise, the VK provider 322 can delete the remove signal from the application. VK provider 322 decides whether the characteristics of the text window are same as the format text characteristics. Regular text characteristics include text input characteristics except the format text characteristics.

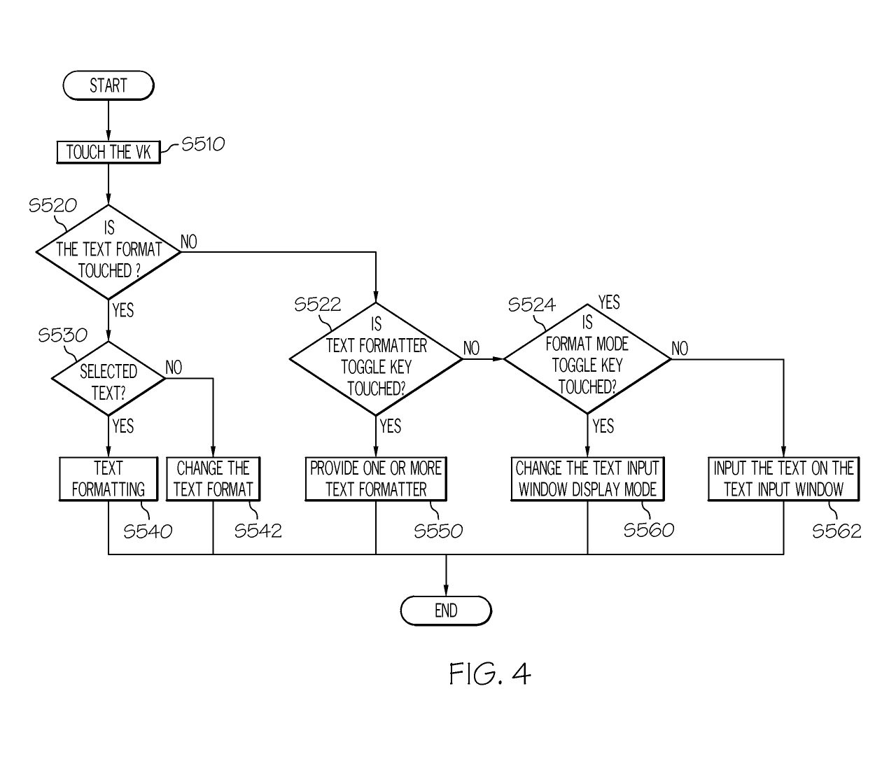

FIG. 4 depicts an example formatted text input process flow diagram according to the present invention. The VK processor 324 extracts the input from the VK 610 and receives the input key as shown in step S510. The VK 610 input may be a touch from a finger. When the user touches the touch screen 310, the touch screen 310 extracts the touch position and sends the touch position information to the controller 320. When the touch position is in the VK 610, then the controller 320 provides an input key to the VK processor 324. VK Processor 324 examines whether the input key is one of the text formatter 612 as shown in step S520.

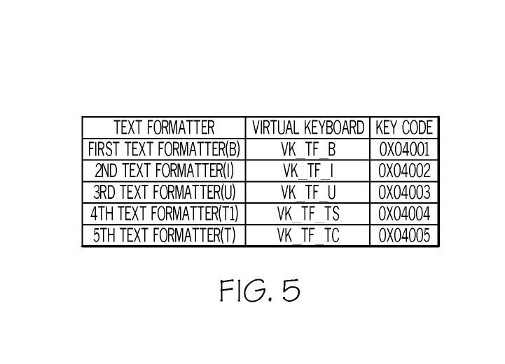

FIG. 5 shows the chart of the text formatter 612 key code. When the first text formatter (B) is touched, the controller 320 provides the first text formatter (B) key code (0x04001) to the VK processor 324 and the VK processor 324 can determine that the key code (0x04001) is the first text formatter B.

When the input key is a text formatter 612, then the VK processor 324 tests the text input window 322 having the selected text. The text selection can be a drag in the special area or word's double touch. When the selected text is in the text input window, the VK processor 324 starts the formatting as shown in step S540. The formatting can be the markup language for the selected text.

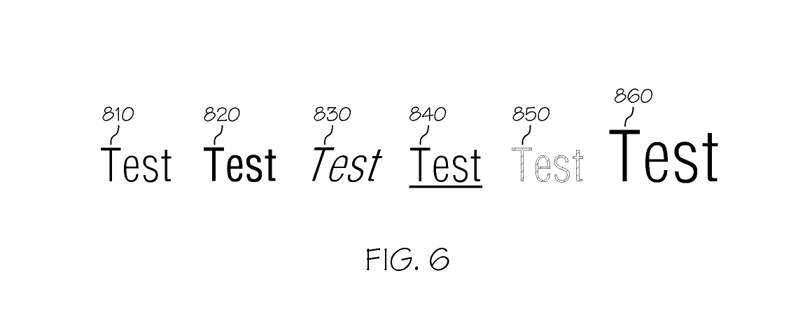

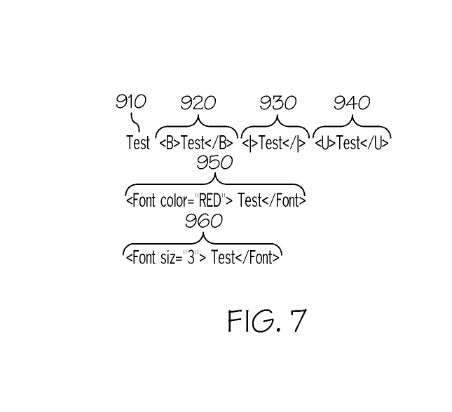

FIG. 6 depicts a formatted text in format mode according to the present invention. FIG. 7 depicts a formatted text in original mode according to the present invention. For example, when the current selected text is the first text formatter (B) Test 810 in FIG. 6, the current selected text formatting is the same as the second text (<B>Test<B>) 820 in FIG. 7, then the text input display 322 can present the text in FIG. 6 or second text 820 in FIG. 7.

When there is no selected text on the text input window 322, then VK processor 324 starts the text formatting shown in step S542. The formatting is done via the markup language and the display is done between the start and the end tags. For example, if the input key is the second text formatter, then the typed input text will be displayed between the start tag (<I>) and the end tag (</I>). And if the input key is the second text formatter (I), again, then the input text can be displayed after the end tag (</I>).

As shown in FIG. 4, the VK processor 324 examines whether the input key is the text formatter toggle key 614 in the step S522. When the output of this test is yes, then it provides one or more texts S550. Test formatter 612 can be displayed above the VK. In such a display, the text formatter toggle key adjusts the VK size based on the application area.

If the input key belongs to the text formatter toggle key, then the VK processor 324 deletes one or more text formatter 612 or displays it. The VK processor 324 sends a message to the controller 320 that the size has been altered. When the controller 320 receives the message, it controls the size and location of the application, and the display processor 326 alters the application 330 size and display. VK processor 324 tests whether the input key is the format mode toggle key S524, and toggles S560 the display mode (e.g. original mode or format mode) of the text input window.

When the display mode is toggled, the VK processor 324 sends a display mode change message to the keyboard controller 320. The keyboard controller sends a display mode change message to the Application. The application sends the display mode change message through the text input window to the text formatting module to alter the display of the text (e.g., bold, italic, underline, etc.) accordingly on the display. The text formatting module 323 interprets the markup language on the text input window and displays it accordingly. The format toggle key can toggle between the original text mode and the format mode. If the input key is text key (e.g. alphabet key), the VK processor 324 inputs the key as shown in step S562. When the text is inputted, the VK processor 324 sends the UNICODE or ASCII CODE to the controller 320 accordingly. The controller 320 sends the application-related text code to the application 330. The text formatting module 334 displays the original text or the formatted text accordingly.

While shown and described herein as a virtual keyboard solution, it is understood that the invention further provides various alternative embodiments. For example, in one embodiment, the invention provides a computer-readable/useable medium that includes computer program code to enable a computer infrastructure to provide virtual keyboard functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.).

In another embodiment, the invention provides a computer-implemented method for providing a virtual keyboard. In this case, a computer infrastructure, such as computer system, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system, from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A system for providing a virtual keyboard, comprising:
an application, comprising:
a text input window configured to receive input; and
a text formatting module configured to format text characters;
a controller, comprising:
a virtual keyboard provider configured to receive a virtual keyboard trigger;
a virtual keyboard processor; and
a display processor configured to display a virtual keyboard; and
a touch screen.

2. The system of claim 1, wherein the virtual keyboard includes at least one text formatter.

3. The system of claim 1, wherein the virtual keyboard includes at least one text format toggle key.

4. The system of claim 1, wherein the virtual keyboard includes at least one format mode toggle key.

5. The system of claim 1, wherein the touch screen is configured as a display device.

6. A method for displaying a virtual keyboard, comprising:
receiving a virtual keyboard trigger signal;
detecting at least one text characteristic;
formatting a plurality of text characters using the at least one text characteristic;
providing at least one virtual keyboard; and
adjusting at least one display of an application or the at least one virtual keyboard.

7. The method of claim 6, wherein the at least one virtual keyboard includes a text formatter.

8. The method of claim 6, wherein the at least one virtual keyboard does not include a text formatter.

9. The method of claim 6, wherein the virtual keyboard trigger signal includes a touch of a finger.

10. The method of claim 6, wherein the at least one virtual keyboard includes a hypertext markup language (HTML) formatted text interface.

11. A method for deploying a virtual keyboard, comprising:
receiving a virtual keyboard trigger signal;
detecting at least one text characteristic;
formatting a plurality of text characters using the at least one text characteristic;
providing at least one virtual keyboard; and
adjusting at least one display of an application or the at least one virtual keyboard.

12. The method of claim 11, wherein the at least one virtual keyboard includes a text formatter.

13. The method of claim 11, wherein the at least one virtual keyboard does not include a text formatter.

14. The method of claim 11, wherein the virtual keyboard trigger signal includes a touch of a finger.

15. The method of claim 11, wherein the at least one virtual keyboard includes an HTML formatted text interface.

16. A computer program product for displaying a virtual keyboard, the computer program product comprising a computer readable storage media, and program instructions stored on the computer readable storage media, to:
receive a virtual keyboard trigger signal;
detect at least one text characteristic;
format a plurality of text characters using the at least one text characteristic;
provide at least one virtual keyboard; and
adjust at least one display of an application or the at least one virtual keyboard.

17. The computer program product of claim 16, wherein the at least one virtual keyboard includes a text formatter.

18. The computer program product of claim 16, wherein the at least one virtual keyboard does not include a text formatter.

19. The computer program product of claim 16, wherein the virtual keyboard trigger signal includes a touch of a finger.

20. The computer program product of claim 16, wherein the at least one virtual keyboard includes an HTML formatted text interface.
